(19) United States
(12) Patent Application Publication
(10) Pub. No.: US 2015/0379074 A1
(43) Pub. Date: Dec. 31, 2015

(54) IDENTIFICATION OF INTENTS FROM QUERY REFORMULATIONS IN SEARCH

(71) Applicant: Microsoft Corporation, Redmond, WA (US)

(72) Inventors: Clemens Marschner, Munich (DE); Mikhail Basilyan, Seattle, WA (US)

(73) Assignee: Microsoft Corporation, Redmond, WA (US)

(21) Appl. No.: 14/316,719

(22) Filed: Jun. 26, 2014

(51) Int. Cl. G06F 17/30

(52) U.S. Cl. CPC G06F 17/30442; G06F 17/30864; G06F 17/30707; G06F 17/30395

(57) ABSTRACT

Architecture that enables the grouping of the same or highly similar intents that are discovered through query reformulation, identifies single intent sessions, and then performs classification of the queries within the single session to determine a change in intent. Queries in a search session that are reformulations of an original query are identified, and the reformulations are distinguished from queries that are issued in a similar sequence to the original query, but cover a completely unrelated intent. When given a user query, a set of accurate and appropriate reformulations are determined, and then used. Additionally, the reformulations can be displayed in accordance with an auto-suggestion technology while the user is still typing, and the reformulations can be displayed when the result screen is displayed as related searches (“Related Searches”). The reformulations can also be used when issuing the query to the search engine.

### BACKGROUND

A search query in a search engine is an attempt of a user to formulate search intent by means of human language. Since language can be ambiguous, oftentimes, there are different ways to express this intent (paraphrases), and document creators may also use slightly different language to express the “answer” to a particular search problem. Identifying the search intent given a query and mapping it to the information contained in documents is a significant challenge in the search technology.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a mechanism to group the same or highly similar intents that are discovered through query reformulation. The architecture identifies single intent sessions and then performs classification of the queries within the single session to determine a change in intent.

The architecture identifies queries in a search session that are reformulations of an original query, and distinguishes the reformulations from queries that are issued in a similar sequence to the original query, but cover a completely unrelated intent. More specifically, the architecture, when given a user query, can determine a set of accurate and appropriate reformulations, and then use the reformulations. Additionally, the reformulations can be displayed in accordance with an auto-suggestion technology while the user is still typing. Additionally, the reformulations can be displayed when the result screen is displayed as related searches (“Related Searches”). The reformulations can be used when issuing the query to the search engine.

The architecture enables a system of identifying intent from query reformulations in accordance with the disclosed architecture. The system can include an identification component configured to identify reformulated queries of a search session that are reformulations of original queries. A mapping component can be included and configured to map the reformulated queries to intent classes based on intent classification criteria, to generate mapped reformulated queries. The system can also comprise a grouping component configured to group the mapped reformulated queries into sets of single intent based on grouping criteria.

The grouping criteria are based on time to a previous reformulated query, number of clicks, and dwell time per webpage. The sets of single intent are each grouped based on intent classification criteria defined as a sequence of new intent followed by a same intent. The mapping component maps the reformulated queries to the intent classes based on a feature vector of properties of an original query and associated reformulated queries. The mapping component maps each query of a set of single intent (e.g., a set of single intent) to at least one of a next query, a specific number of next queries, the optimum query of a search session, or an optimum query in any search session.

The architecture enables at least one method where reformulated queries of a search session are identified that are reformulations of original queries. The reformulated queries are mapped to intent classes based on intent classification criteria. The mapped reformulated queries are grouped into sets of single intent based on grouping criteria, and an optimum query is selected from each set of single intent. The optimum queries from multiple sessions are aggregated for at least one of presentation or results processing.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system of identifying intent from query reformulations in accordance with the disclosed architecture.

FIG. 2 illustrates an alternative system of identifying intent from query reformulations.

FIG. 3 illustrates a diagram of a series of queries as issued by the same user, along with time to the previous queries and data about result clicks and the amount of time spent on the result.

FIG. 4 illustrates some features utilized as intent classification criteria for mapping queries to intent classifications.

FIG. 5 illustrates a method in accordance with the disclosed architecture.

FIG. 6 illustrates an alternative method in accordance with the disclosed architecture.

FIG. 7 illustrates a block diagram of a computing system that executes identification of intents from query reformulations in accordance with the disclosed architecture.

### DETAILED DESCRIPTION

The disclosed architecture describes a mechanism to group the same or highly similar intents that are discovered through query reformulation. Users reformulate queries to indicate their original intent for the search. In a simple operation, a user enters a query, and thereafter, the user enters another query, a reformulated query of the same session. It can be inferred that the second (reformulated) query is an improvement over the first query. One scheme is to simply map every query to the next query in that session.

Techniques for statistical modeling, such as conditional random field (CRF), can be used to detect intent changes within session of a predetermined time span (e.g., thirty seconds).

The architecture can examine whole sessions of queries with the same or significantly related intent. A goal is to identify single intent sessions and then classify within the single session to determine a change in intent.

Reformulations in a session can be treatred as a segmentation problem. Sessions can be parsed into sub-sessions of contiguous queries. Mapping is then applied to compute which queries to map to which other queries. This aides in ranking to predict future reformulations before user has typed the reformulaiton. Reformulated queries can be mined from search logs and used to train a translation model. Ranking can then be applied.

Mining reformulated queries can include examining queries issued by the same user within five minutes, for example, of each query (e.g., two consecutive queries), generating statistics (“extract features”) for the two queries, labeling the training set, and building a classifier. For each pair of queries, features are computed on pairs of queries, within a predetermined time span (e.g., five minutes) for queries issued by the same user. The features computed on each pair, can include, but are not limited to, the following: the time between queries and the inverse; |Q1| is the number of words in query Q1; |Q2| is the number of words in query Q2; |Q1|∩Q2|/max(|Q1|,|Q2|); the Jaccard index=|Q1|∩Q2|/|Q|•Q2|; |Q1|∩Q2|; Max(|Q1|, |Q2|); Min(|Q1|,|Q2|); and, LevenshteinDistance(Q1, Q2).

The applications of the architecture range from explicitly showing certain paraphrases (“suggestions”, or “related searches”) to implicitly issuing queries that are found to be more successful finding answers to a particular search problem than the query explicitly entered.

A typical interaction of a user with a search engine can comprise several feedback cycles where the user enters a query, views and investigates the results, and returns to the search engine to issue another query, until the user reaches an endpoint where the information intent is either fulfilled or the task is abandoned. This sequence of such events (e.g., queries, clicks) within a particular time window (span) is referred to as a “search session”.

The architecture identifies queries in a search session that are reformulations of an original query, and distinguishes the reformulations from queries that are issued in a similar sequence to the original query, but cover a completely unrelated intent.

More specifically, the architecture, when given a user query, can determine a set of accurate and appropriate reformulations, and then use the reformulations. Additionally, the reformulations can be displayed in accordance with an auto-suggestion technology while the user is still typing. Additionally, the reformulations can be displayed when the result screen is displayed as related searches (“Related Searches”). The reformulations can be used when issuing the query to the search engine.

Other features for every query in the session can include the time difference to previously submitted query (in seconds), the clicks received by that query across sessions, query submissions across sessions, sequence number within the session, sequence number within the session counted from the end of the session, length of the session (measured in the number of queries issued), the number of removed tokens compared to previous query, the number of replaced tokens compared to previous query, the number of added tokens compared to previous query, the number of same tokens compared to previous query, character-based edit distance (Levenshtein distance) compared with previous query, length of the previous query (in characters), length of the session (in queries issued), and the number of clicks the query received in this session.

Still other features can include the length of the query (in tokens), the overlap of URLs (uniform resource locators) shown for this query compared to the previous query, the Jaccard overlap to the previous query (on the sets of tokens), Boolean: query is the same as previous query, Boolean: query is first query in session, the query is one of the top n most frequent queries, Boolean: query length is one, Boolean: query length is two, the maximum dwell time (e.g., in seconds) on any of the clicked pages, and the minimum dwell time (e.g., in seconds) on any of the clicked pages.

An alternative to the disclosed architecture can consider other features such as queries are defined to have the same intent if they are issued within X minutes of each other and by the same user, have Y words in common, have a specific edit distance in terms of characters/words (e.g., Levenshtein distance, Jaccard index, etc.).

The disclosed architecture can be utilized in other implementations, such as a chatbot (robotic program designed to handle certain chat functions) that can detect changes in topic, in a conversation with a bot such as a speech recognition program designed to respond to user commands and requests, in which application it can be possible to detect when the user switches intent, and then the bot reacts accordingly, and a product search program and other search verticals.

The general architecture can comprise the following steps:

(1) Each entry in the session is mapped to one of several classes c, such as “same intent” s or “new intent” n; where cε{s, n} through a function \vec{ƒ}→c.

(2) The session now contains a mapping of queries on the time axis to sequences of elements of class c; such as {n, n, s, n, s, s}, for example. Every sequence {n, s . . . } can be extracted and considered to represent a single intent.

(3) From these queries, the most “successful” query is identified.

(4) Each query in the same single-intent session can now be mapped to, a) the next query, assuming queries get better as they are reformulated, b) the n next queries, c) to the most successful query in the session, d) the most successful query in any search session, or e) map all queries to all queries.

(5) These mappings are aggregated over all sessions to arrive at a relation Q×Q, which maps less successful queries to more successful queries.

(6) When a user enters a query, the list of “more successful” queries can be looked up and: a) displayed while the user is still typing (“suggestion”); b) displayed when the result screen is displayed (“Related Searches”); c) used when issuing the query to the search engine itself, etc. However, the look-up need not be solely the more successful queries, but can be, alternatively or in combination therewith, queries that are related, whether more successful or not.

Another method involves n queries that are of the same intent. The method takes all the queries in that list as the source, and the target query will be the best of those source queries. The best query usually is associated with a dwell time of more than thirty seconds. Another optional method maps every single query to every single other query (all the permutations). Yet another option is that the first query maps to each subsequent query, the second query maps to each subsequent query, and so on. Then pick all the best queries, which there may be numerous such queries.

It is to be understood that although the description may direct focus to online search engines, the disclosed architecture also finds application to personal device/system/computer search programs, such that a search for data on a personal computer may also benefit from the disclosed intent and reformulation capabilities described herein. For example, query reformulations to a specific document on the user computer can be processed according to sessions, intents, etc., and presented as results to the user in a manner similar to online searches and search results.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

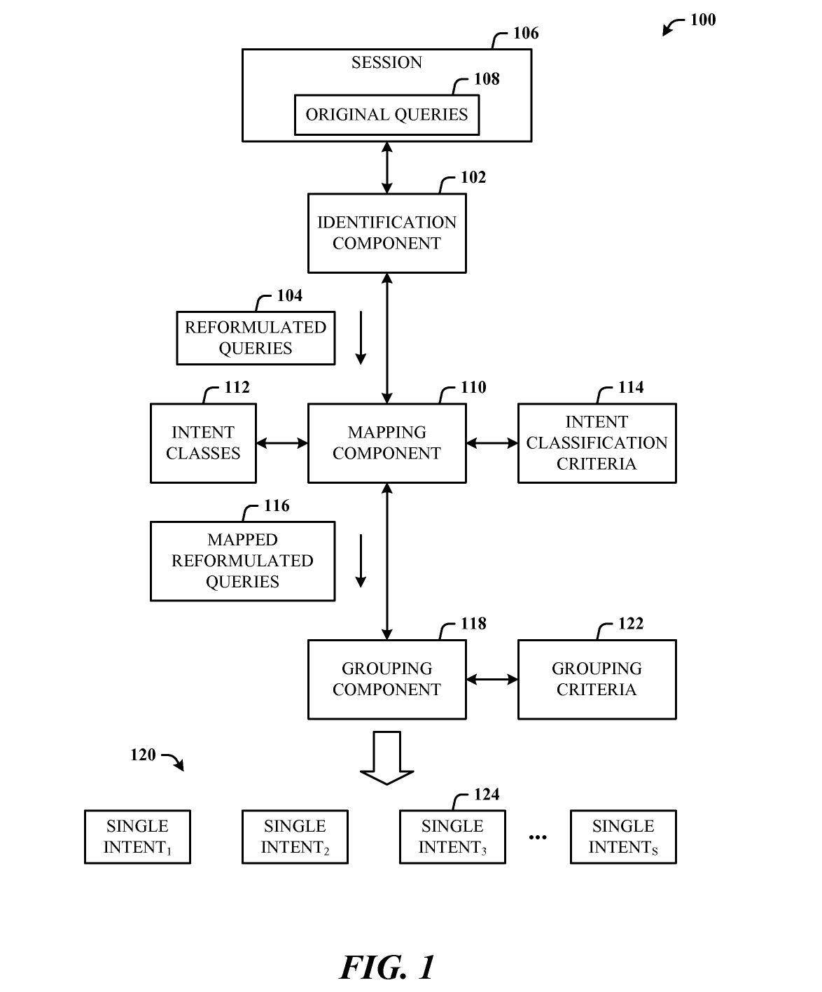

FIG. 1 illustrates a system 100 of identifying intent from query reformulations in accordance with the disclosed architecture. The system 100 can include an identification component 102 configured to identify reformulated queries 104 of a search session 106 that are reformulations of original queries 108. A mapping component 110 can be included and configured to map the reformulated queries 104 to intent classes 112 based on intent classification criteria 114, to generate mapped reformulated queries 116. The system 100 can also comprise a grouping component 118 configured to group the mapped reformulated queries 116 into sets of single intent 120 (e.g., Single Intent₁, . . . , Single Intent_{S}) based on grouping criteria 122.

The grouping criteria 122 are based on time to a previous reformulated query, number of clicks, and dwell time per webpage. The sets of single intent 120 are each grouped based on intent classification criteria 114 defined as a sequence of new intent followed by a same intent. The mapping component 110 maps the reformulated queries 104 to the intent classes 112 based on a feature vector of properties of an original query and associated reformulated queries. The mapping component 110 maps each query of a set of single intent (e.g., a set of single intent 124) to at least one of a next query, a specific number of next queries, the optimum query of a search session, or an optimum query in any search session.

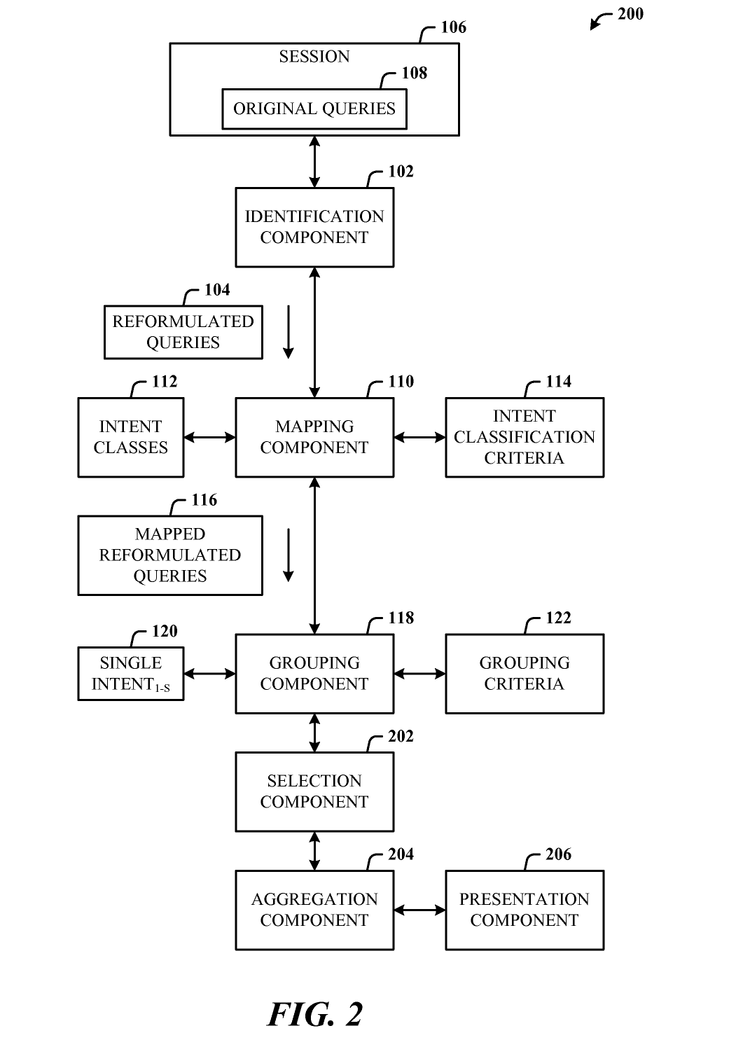

FIG. 2 illustrates an alternative system 200 of identifying intent from query reformulations. The system 200 comprises the system 100 of FIG. 1, as well as a selection component 202, an aggregation component 204, and a presentation component 206. The selection component 202 is configured to select an optimum query from queries of each set of single intent (the sets of single intent 120). The optimum query of a set of single intent is selected based on at least one of largest number of user interactions not followed by a query reformulation, user dwell time on selected target websites, or manual reviews of target websites.

The aggregation component 204 can be configured to aggregate the optimum queries from multiple sessions for at least one of presentation or results processing, and the presentation component 206 can be configured to present a list of successful queries when a new query is entered, the successful queries employed at least one of in an auto-suggestion technology, as related searches, as a direct query to a search engine, or in document ranking.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remote service.

More specifically, the architecture, when given a user query, can determine a set of accurate and appropriate reformulations, and then use the reformulations. Additionally, the reformulations can be displayed in accordance with an auto-suggestion technology while the user is still typing. The reformulations can be displayed when the result screen is displayed as related searches (“Related Searches”). The reformulations can be used when issuing the query to the search engine. Rather than just submitting the query q, all the query paraphrases of more successful queries q₁ OR q₂ OR q₃ . . . are also submitted; hence, changing the set of documents to consider for ranking. The reformulations can be used for determining the ranking of the document itself and as features for the ranking method.

In other words, let S be a search session comprised of tuples <q, t, \vec{ƒ}> where q is a query, t is a timestamp when the query was issued, creating an ordering of queries on the time axis, and \vec{ƒ} is a feature vector that defines further properties of the query in the session. The properties may include, but are not limited to, the length of the query, the number of clicks that were performed on the results, the time from the previously issued query, the number of common or changed words from the previous query, and the overall query frequency across users.

Other features for every query in the session can include the time difference to previously submitted query (in seconds), the clicks received by that query across sessions, query submissions across sessions, sequence number within the session, sequence number within the session counted from the end of the session, length of the session (measured in the number of queries issued), the number of removed tokens compared to previous query, the number of replaced tokens compared to previous query, the number of added tokens compared to previous query, the number of same tokens compared to previous query, character-based edit distance (Levenshtein distance) compared with previous query, length of the previous query (in characters), length of the session (in queries issued), and the number of clicks the query received in this session.

Still other features can include the length of the query (in tokens), the overlap of URLs (uniform resource locators) shown for this query compared to the previous query, the Jaccard overlap to the previous query (on the sets of tokens), Boolean: query is the same as previous query, Boolean: query is first query in session, the query is one of the top n most frequent queries, Boolean: query length is one, Boolean: query length is two, the maximum dwell time (e.g., in seconds) on any of the clicked pages, and the minimum dwell time (e.g., in seconds) on any of the clicked pages.

It is to be appreciated that features are not solely dependent on the query, but can also take into consideration, characteristics of the user (e.g., user profile information), user location (e.g., geographical location, location on a network, etc.), user history (e.g., prior actions, results, choices, content, etc.), documents the user has selected (“clicked on”) in this query, documents selected in past interactions/queries, and so on.

The architecture can comprise the following more specific steps:

(1) Each entry in the session is mapped to one of several classes c, such as “same intent” s or “new intent” n; where cε{s, n} through a function \vec{ƒ}→c. The function may be built using heuristics such as “The intent is considered to be ‘s’ if it is not the first query and at least ¾ of the words are the same as the previous query; otherwise ‘n’”. The function may be created manually (e.g., through crowd sourcing) or the function may be a machine learned classifier trained to maximize the probability of a training set of sessions manually annotated with elements of class c.

(2) The session now contains a mapping of queries on the time axis to sequences of elements of class c; such as {n, n, s, n, s, s}, for example. Every sequence {n, s . . . } can be extracted and considered to represent a single intent.

(3) From these queries, the most “successful” query is identified. For example, success may be defined by the paraphrase that receives the largest number of clicks that were not followed by any further reformulations, by the amount of time the users spent on the clicked sites, through manual reviews of the target sites, can be manually determined (e.g., NDCG (normalized discounted cumulative gain) style), and/or by dwell time.

(4) Each query in the same single-intent session can now be mapped to, a) the next query, assuming queries get better as they are reformulated, b) the n next queries, c) to the most successful query in the session, d) the most successful query in any search session, or e) map all queries to all queries.

(5) These mappings are aggregated over all sessions to arrive at a relation Q×Q, which maps less successful queries to more successful queries.

(6) When a user enters a query, the list of “more successful” queries is looked up and can be: a) displayed while the user is still typing (“suggestion”); b) displayed when the result screen is displayed (“Related Searches”); c) used when issuing the query to the search engine itself. Rather than submitting the query q, all its paraphrases of more successful queries q₁ OR q₂ OR q₃ . . . are submitted or used within the ranker or to improve document matching; hence changing the set of documents considered for ranking; and, d) used for determining the ranking of the document itself as features for the ranking method.

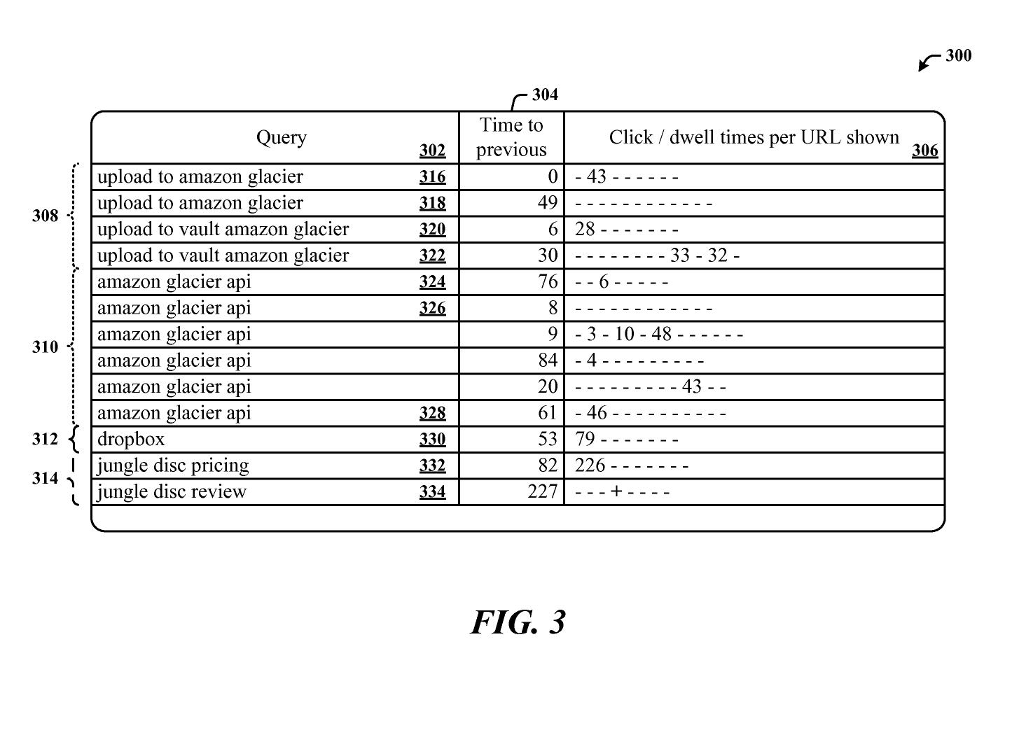

FIG. 3 illustrates a diagram 300 of a series of queries 302 as issued by the same user, along with time to the previous queries 304 and data 306 about result clicks and the amount of time spent on the result. Given a set of queries issued by the same user, a goal is to group the queries as to classes of intent (e.g., new intent, same intent, etc.). Braces (“{ }”) are used to indicate grouped queries in the session and according to time. In the third column, each number and dash or hyphen (“-”) represents one URL (uniform resource locator) on the display. The dash (or hyphen) indicates the document for that URL was displayed, but not clicked, whereas the number indicates the URL was clicked and the amount of time the user stayed on the documents (the “dwell time”).

There are three sessions in this example: a first session that encompasses queries grouped as a first group 308 and a second group 310, a second session for a third group 312, and a third session for the fourth group 314. The brackets indicate grouped queries in the sessions and according to time: groups 308, 310, 312, and 314. The groups 308 and 310 of queries are classified as a set of queries having a single intent (as indicated by the dotted brackets) of the session. The first query 316 (“upload to amazon glacier”) is entered by the user as an original query at a time zero.

Thus, with respect to the first query 316, the user issued the first query 316 at the beginning of the first session (at time zero (0)), and then investigated the second result (web document at the associate URL) for a dwell time of forty-three (43) seconds. Within the next six (6) seconds, the user then reissued the same first query 316 as a second query 318 (or forty-nine (49) seconds after the previous time, which was session start. After execution of the second query 318, the user chose not to navigate to any of the result pages (or documents) as indicated by the dashes.

Within the next six (6) seconds, the user then reformulated the second query 318 as reformulated query 320 by inserting the term “vault”, selected (“clicked on”) the first of eight results (the number plus seven dashes), and dwelled on the first result URL for twenty-eight (28) seconds. Thirty (30) seconds from the previous query (the third query 320), the same third query 320 was issued in the first session as a fourth query 322 from which twelve results were received (as indicated by ten dashes and two numbers). The user selected the ninth result, dwelled on that URL page for thirty-three (33) seconds, and then selected the eleventh result URL and dwelled on the page for thirty-two (32) seconds.

This defines a first intent of the first session. Thus, the first query 316 is classified ‘n’ as new intent, followed by three same intent classifications of ‘s’. The classification sequence of {n,s} of the first query 316 and the second query 318 identifies the first intent of the first session.

Seventy-six (76) seconds after the fourth query 322, a fifth query 324 (“amazon glacier api”) is issued. The fifth query 324 is classified as “new intent” based on intent classification criteria. A sixth query 326 and subsequent queries to a ninth query 328 are classified as “same intent” queries. The classification sequence of {n,s} of the fifth query 324 and the sixth query 326 identifies the second intent of the first session.

From this data, the algorithm is enabled to infer that a query “amazon vault amazon glacier” will be either a suggested query for “upload to amazon glacier”; otherwise, used for other purposes, such as ranking, etc.

In the second session for the third group 312, the user issues the tenth query 330 (“dropbox”), fifty-three (53) seconds after the ninth query 328 of the first session. The user dwells seventy-nine (79) seconds on the first of eight results. Within three seconds of the leaving the first of eight results of the tenth query 330, the user issues an eleventh query 332 in a third session. While the tenth query 330 may be a new query relative to the ninth query 328, the tenth query 330 is not classified as new intent, since an eleventh query 332 (“jungle disc pricing”) is not classified as same intent, and the {n,s} sequence is not detected.

Within eighty-two (82) seconds of leaving the first of eight results of the eleventh query 332, the user issues a twelfth query 334. With the twelfth query 334 classified as a “same intent” query, the {n,s} sequence is detected and the group 314 is a new intent group (or set).

Using the above information, a classifier can be trained using features, and each query labeled by same intent ‘s’ or new intent ‘n’. Once trained, the classifier is applied to a new user search session and these labels are derived for each query. Accordingly, in the first session (group 308 and 310), the first query 316 is tagged ‘n’ for new intent, followed by the three queries tagged as “s” for same intent. In second set (group) of the first session, the first instance of “amazon glacier api” is tagged ‘n’, followed by five queries as same intent ‘s’. The second session is determined by the query “dropbox” and tagged as ‘n’, and the third session is initiated by the query “jungle disk pricing” tagged as ‘n’ followed by a reformulated query “jungle disk review” tagged as ‘s’.

As previously indicated, some or all of the user sessions can be aggregated. Duplicates can be removed from the grouped queries and the best reformulated query is obtained. Moreover, a scheme is provided that maps worst queries to better queries.

The disclosed architecture can optionally include a privacy component that enables the user to opt in or opt out of exposing personal information and search information. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

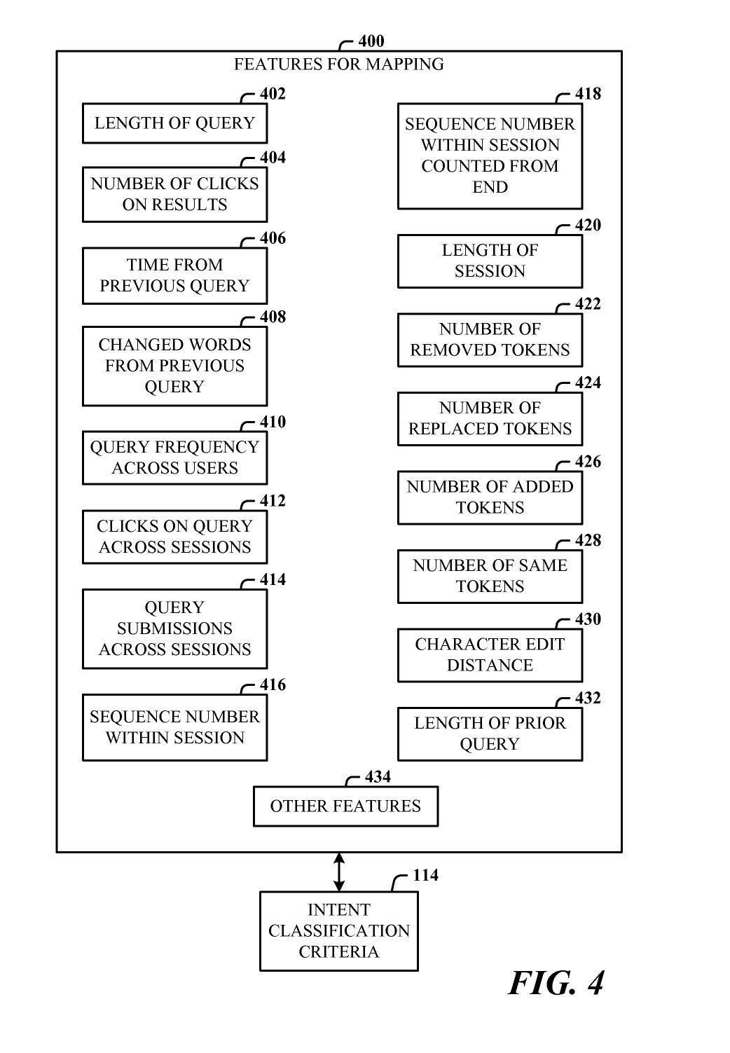

FIG. 4 illustrates some features 400 utilized as intent classification criteria for mapping queries to intent classifications. The features 400 can include, but are not limited to, the length of the query 402, the number of clicks that were performed on the results 404, the time (e.g., in seconds) from the previously issued query 406, the number of common or changed words from the previous query 408, and the overall query frequency across users 410.

Other features for every query in the session can include, the clicks received by that query across sessions 412, query submissions across sessions 414, sequence number within the session 416, sequence number within the session counted from the end of the session 418, length of the session (measured in the number of queries issued) 420, the number of removed tokens compared to previous query 422, the number of replaced tokens compared to previous query 424, the number of added tokens compared to previous query 426, the number of same tokens compared to previous query 428, character-based edit distance (Levenshtein distance) compared with previous query 430, and length of the previous query (in characters) 432.

Still other features 434 include length of the session (in queries issued), the number of clicks the query received in this session, the length of the query (in tokens), the overlap of URLs (uniform resource locators) shown for this query compared to the previous query, the Jaccard overlap to the previous query (on the sets of tokens), Boolean: query is the same as previous query, Boolean: query is first query in session, the query is one of the top n most frequent queries, Boolean: query length is one, Boolean: query length is two, the maximum dwell time (e.g., in seconds) on any of the clicked pages, and the minimum dwell time (e.g., in seconds) on any of the clicked pages, just to name a few.

Following is a table of example source queries and possible target queries.

TABLE 1
Example Source/Target Queries

| Source | Target |
|---|---|
| beach themed wedding cakes | beach theme wedding |
| beach umbrella target | beach umbrella |
| bear mountain | bear mountain new york |

For example, given the query “beach themed wedding cakes”, a related query/intent identified by the architecture may be “beach theme wedding (depending on the application).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

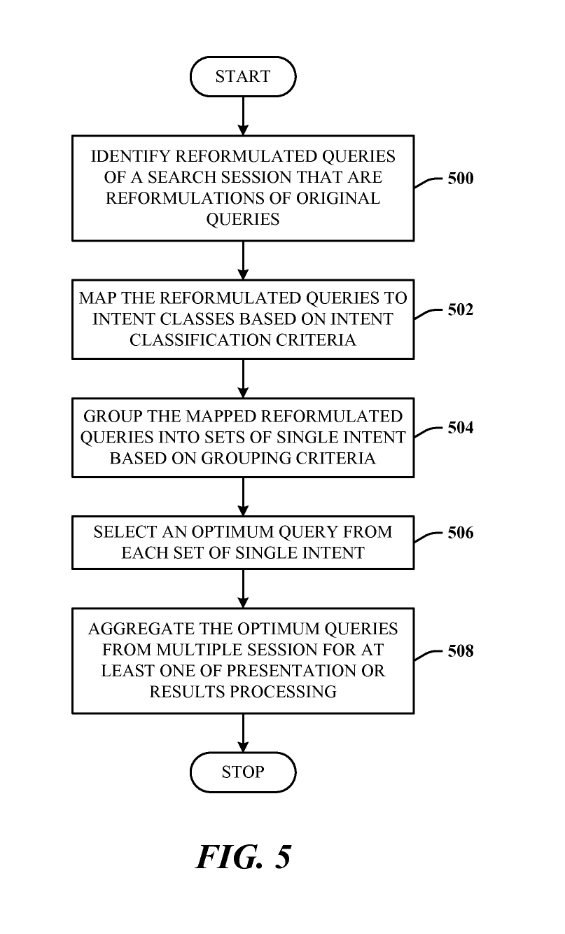

FIG. 5 illustrates a method in accordance with the disclosed architecture. At 500, reformulated queries of a search session are identified that are reformulations of original queries. At 502, the reformulated queries are mapped to intent classes based on intent classification criteria. At 504, the mapped reformulated queries are grouped into sets of single intent based on grouping criteria. At 506, an optimum query is selected from each set of single intent. At 508, the optimum queries from multiple sessions are aggregated for at least one of presentation or results processing.

The method can further comprise defining the intent classification criteria according to query order among other queries and query structure relative a prior query. The method can further comprise mapping the reformulated queries according to time and sequences of intent classes. The method can further comprise grouping the mapped reformulated queries based on intent classifications as the grouping criteria. The method can further comprise selecting the optimum query of a set of single intent based on at least one of largest number of user interactions not followed by a query reformulation, user dwell time on selected target websites, or manual reviews of target websites.

The method can further comprise mapping each query of a set of single intent to at least one of a next query, a specific number of next queries, the optimum query of a search session, or an optimum query in any search session. The method can further comprise presenting a list of successful queries when a new query is entered, the successful queries employed at least one of in an auto-suggestion technology, as related searches, as a direct query to a search engine, or in document ranking.

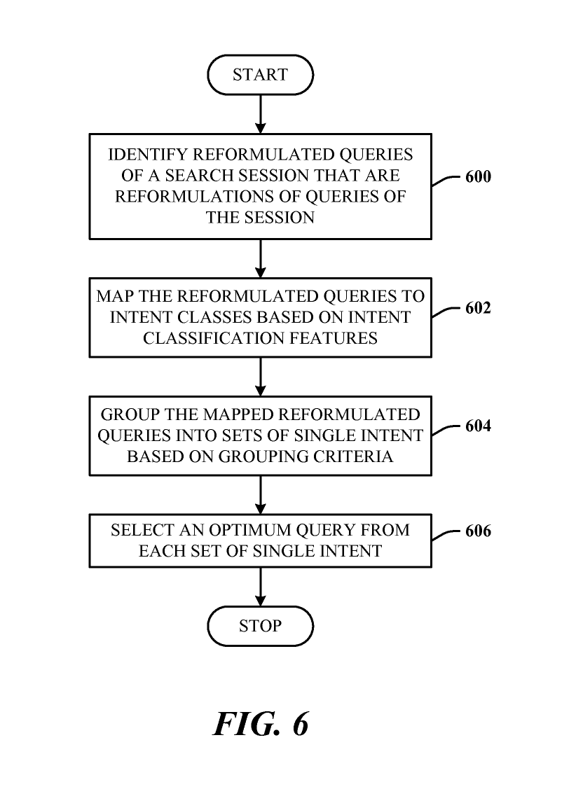

FIG. 6 illustrates an alternative method in accordance with the disclosed architecture. The method can be implemented in a computer-readable storage medium comprising computer-executable instructions that when executed by a microprocessor, cause the microprocessor to perform the following acts.

At 600, reformulated queries of a search session that are reformulations of queries of the session, are identified. At 602, the reformulated queries are mapped to intent classes based on intent classification features. At 604, the mapped reformulated queries are grouped into sets of single intent based on grouping criteria. At 606, an optimum query is selected from each set of single intent.

The method can further comprise aggregating the optimum queries from multiple sessions for at least one of presentation or results processing and presenting a list of successful queries when a new query is entered, the successful queries employed at least one of in an auto-suggestion technology, as related searches, as a direct query to a search engine, or in document ranking. The method can further comprise mapping each query of a set of single intent to at least one of a next query, a specific number of next queries, the optimum query of a search session, or an optimum query in any search session. The method can further comprise mapping the reformulated queries according to time and sequences of intent classes.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

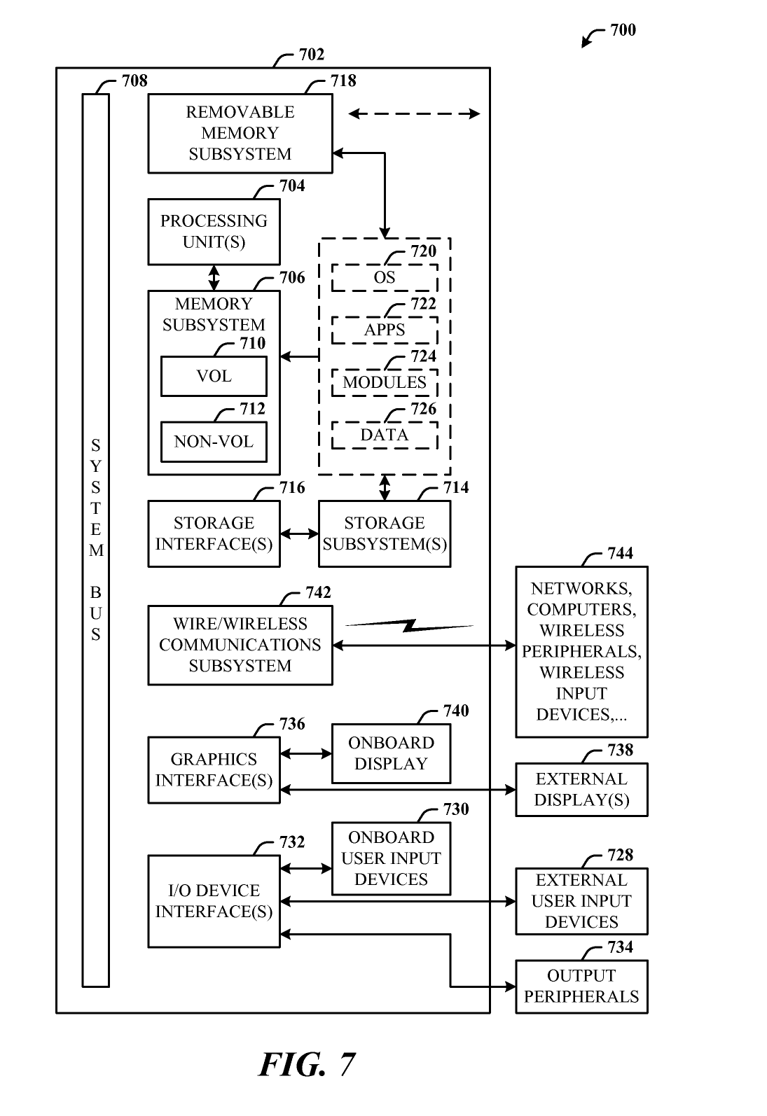

Referring now to FIG. 7, there is illustrated a block diagram of a computing system 700 that executes identification of intents from query reformulations in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having microprocessing unit(s) 704 (also referred to as microprocessor(s) and processor(s)), a computer-readable storage medium such as a system memory 706 (computer readable storage medium/media also include magnetic disks, optical disks, solid state drives, external memory systems, and flash memory drives), and a system bus 708. The microprocessing unit(s) 704 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 702 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 706 can include computer-readable storage (physical storage) medium such as a volatile (VOL) memory 710 (e.g., random access memory (RAM)) and a non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the microprocessing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components and circuits. The storage subsystem(s) 714 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include items and components of the system 100 of FIG. 1, items and components of the system 200 of FIG. 2, items and structure of the diagram 300 of FIG. 3, features 400 of FIG. 4, and the methods represented by the flowcharts of FIGS. 5 and 6, for example.

Generally, programs include routines, methods, data structures, other software components, etc., that perform particular tasks, functions, or implement particular abstract data types. All or portions of the operating system 720, applications 722, modules 724, and/or data 726 can also be cached in memory such as the volatile memory 710 and/or non-volatile memory, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 702, and include volatile and non-volatile internal and/or external media that is removable and/or non-removable. For the computer 702, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 702, programs, and data using onboard user input devices 730 such a touchpad, microphone, keyboard, etc., where the computer 702 is a portable computer, for example.

These and other input devices are connected to the microprocessing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an identification component configured to identify reformulated queries of a search session that are reformulations of original queries;
a mapping component configured to map the reformulated queries to intent classes based on intent classification criteria;
a grouping component configured to group the mapped reformulated queries into sets of single intent based on grouping criteria; and
at least one microprocessor configured to execute computer-executable instructions in a memory associated with the identification component, mapping component, and grouping component.

2. The system of claim 1, further comprising a selection component configured to select an optimum query from queries of each set of single intent.

3. The system of claim 2, wherein the optimum query of a set of single intent is selected based on at least one of largest number of user interactions not followed by a query reformulation, user dwell time on selected target websites, or manual reviews of target websites.

4. The system of claim 1, further comprising an aggregation component configured to aggregate the optimum queries from multiple sessions for at least one of presentation or results processing.

5. The system of claim 1, wherein the grouping criteria are based on time to a previous reformulated query, number of clicks, and dwell time per webpage.

6. The system of claim 1, wherein the sets of single intent are each grouped based on intent classification criteria defined as a sequence of new intent followed by a same intent.

7. The system of claim 1, wherein the mapping component maps the reformulated queries to the intent classes based on a feature vector of properties of an original query and associated reformulated queries.

8. The system of claim 1, wherein the mapping component maps each query of a set of single intent to at least one of a next query, a specific number of next queries, the optimum query of a search session, or an optimum query in any search session.

9. The system of claim 1, further comprising a presentation component configured to present a list of successful queries when a new query is entered, the successful queries employed at least one of in an auto-suggestion technology, as related searches, as a direct query to a search engine, or in document ranking.

10. A method, comprising acts of:
identifying reformulated queries of a search session that are reformulations of original queries;
mapping the reformulated queries to intent classes based on intent classification criteria;
grouping the mapped reformulated queries into sets of single intent based on grouping criteria;
selecting an optimum query from each set of single intent; and
aggregating the optimum queries from multiple sessions for at least one of presentation or results processing.

11. The method of claim 10, further comprising defining the intent classification criteria according to query order among other queries and query structure relative a prior query.

12. The method of claim 10, further comprising mapping the reformulated queries according to time and sequences of intent classes.

13. The method of claim 10, further comprising grouping the mapped reformulated queries based on intent classifications as the grouping criteria.

14. The method of claim 10, further comprising selecting the optimum query of a set of single intent based on at least one of largest number of user interactions not followed by a query reformulation, user dwell time on selected target websites, or manual reviews of target websites.

15. The method of claim 10, further comprising mapping each query of a set of single intent to at least one of a next query, a specific number of next queries, the optimum query of a search session, or an optimum query in any search session.

16. The method of claim 10, further comprising presenting a list of successful queries when a new query is entered, the successful queries employed at least one of in an auto-suggestion technology, as related searches, as a direct query to a search engine, or in document ranking.

17. A computer-readable storage medium comprising computer-executable instructions that when executed by a microprocessor, cause the microprocessor to perform acts of:
identifying reformulated queries of a search session that are reformulations of queries of the session;
mapping the reformulated queries to intent classes based on intent classification features;
grouping the mapped reformulated queries into sets of single intent based on grouping criteria; and
selecting an optimum query from each set of single intent.

18. The computer-readable storage medium of claim 17, further comprising aggregating the optimum queries from multiple sessions for at least one of presentation or results processing and presenting a list of successful queries when a new query is entered, the successful queries employed at least one of in an auto-suggestion technology, as related searches, as a direct query to a search engine, or in document ranking.

19. The computer-readable storage medium of claim 17, further comprising mapping each query of a set of single intent to at least one of a next query, a specific number of next queries, the optimum query of a search session, or an optimum query in any search session.

20. The computer-readable storage medium of claim 17, further comprising mapping the reformulated queries according to time and sequences of intent classes.
